(19) United States
(12) Patent Application Publication
(10) Pub. No.: US 2022/0270185 A1
(43) Pub. Date: Aug. 25, 2022

(54) SURVIVOR ASSAULT MATCHING PROCESS

(71) Applicant: Nathaniel J. Beckford, Bothell, WA (US)

(72) Inventor: Nathaniel J. Beckford, Bothell, WA (US)

(73) Assignee: Diskuv, Inc., Mill Creek, WA (US)

(21) Appl. No.: 17/182,448

(22) Filed: Feb. 23, 2021

(51) Int. Cl. G06Q 50/00; G06F 21/60; G06F 21/71; H04L 29/06

(52) U.S. Cl. CPC G06Q 50/01; G06F 21/606; G06F 21/71; G06F 21/602; H04L 63/306

(57) ABSTRACT

A survivor assault matching process, including the steps of providing information at a secure website concerning the assault and/or alleged assailant; periodically enquiring whether information provided by other assault survivors matches the information provided by the one assault survivor, and providing an opportunity for the one survivor for possible further action if there is a match.

### TECHNICAL FIELD

This invention relates generally to a process for associating survivors of assaults with matching assault and/or assailant information from other survivors. One aspect of the invention is identifying a community network of survivors

### BACKGROUND OF THE INVENTION

Survivors of assault, in particular sexual assault, frequently have few, if any, options or opportunities for pursuing the perpetrators of the assault other than reporting the assault to the police. In many cases, however, assault survivors are generally reluctant to share the information with others, including the police. In some cases, assault survivors decrease the opportunities for legal remedies by contacting other assault survivors, exposing themselves to claims of shaping or modifying individual testimony about the assaults. This often leaves the assault survivor in an ambiguous situation relative to their own feelings and concerns. Further, there is no resulting accountability for the assailant. Many prior art systems approach the issue of assault from a reporting perspective. The present process, however, is directed toward reliably identifying an assailant from information voluntarily and confidentially provided by the survivor and providing the survivor an opportunity to pursue a course of action. Assault survivors have few opportunities for safely indentifying other assault survivors. At times survivors may want to reach out to someone who can understand their pain and anxiety. Many current social networks are directed to connecting with existing friends, but typically providing the survivor no information whether or not sharing their pain of an assault with an existing friend will cause even more problems. One aspect of the present process is directed toward identifying a community of people who have a high degree of confidence that they are mutual survivors.

### SUMMARY OF THE INVENTION

Accordingly, the invention is a survivor assault matching process, comprising the steps of: providing an opportunity for an assault survivor to register at a website; prompting the survivor to provide factual information about the assault; encrypting the provided factual information; providing the encrypted factual information to a computer with database not connected to the internet; periodically inquiring of the computer with database whether or not the information supplied by one assault survivor matches information provided by other assault survivors; and in the event there is a match, providing the one survivor the opportunity to receive an authorization code, which authorization code is then provided to police or an attorney for possible further action, including accessing the matched information from the one survivor and the other survivors

### BRIEF DESCRIPTION OF THE DRAWINGS

FIG. 1 is a diagram showing the overall process of the present invention, with the survivor and the circumstances of the assault/alleged assailant driving the process.

FIG. 2A is a first series of tables defining the meaning of selected terms/actions in the process.

FIG. 2B is a second series of tables defining the meaning of additional terms/actions used in the process.

### BEST MODE FOR CARRYING OUT THE INVENTION

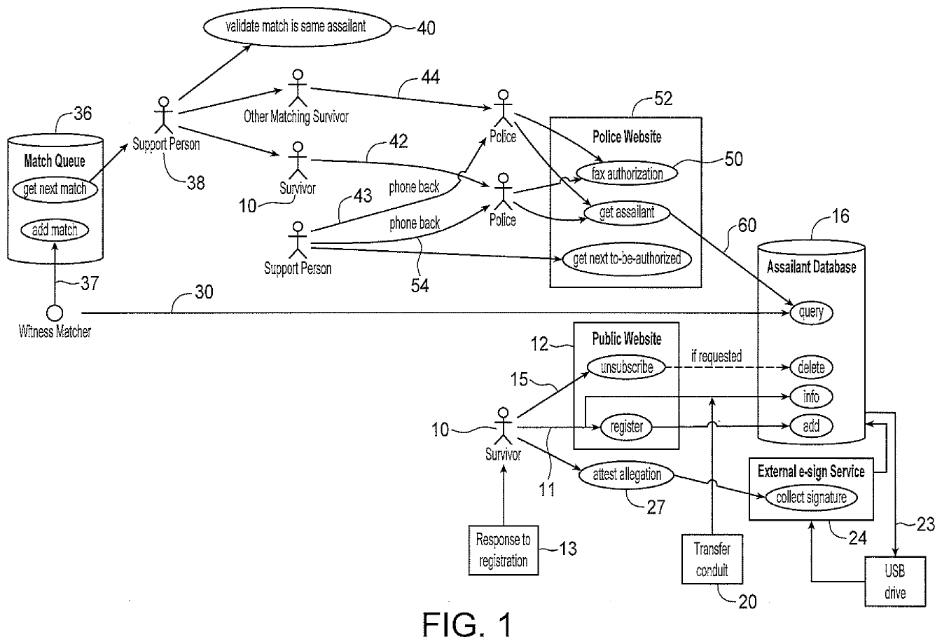

Referring to FIG. 1, the process begins with a survivor of an assault, identified at 10. In a first step in the process, the survivor 10 registers the assault, referred to at 11, on an identified website available to the public, shown at 12. The survivor provides a password of their choosing to the website. The survivor 10 is provided a unique identifier (ID) by the system, and is identified as a “person” by name and as a “user” by an email address or a telephone number. The process correlates the survivor's identity as a “person” and a “user”, in the event that the survivor 10 forgets they registered the assault with a different email and/or phone number. Tables 1, 2 and 4 list the personal information provided for each category (survivor, person and user). This ensures that subsequent information is associated with the original survivor 10. The survivor also provides a “code phrase” for communication with the survivor, as shown in Table 4. In response to a registration, the survivor at 13 is encouraged to take particular steps for assault care, including a hospital visit and/or confidential counseling.

The survivor, following registration, is prompted to provide information about the assault and the alleged assailant. The survivor may choose to later delete the registration, i.e. “unsubseribe”, referred to at 15. The information provided in the current embodiment concerning the assault is provided with a unique assault ID, as shown in Table 5. The zip code in which the assault occurred, the street address or intersection where the assault occurred and the date on which the assault occurred is provided. Other information can be requested in the process concerning the assault as well.

Information about the alleged assailant is also prompted (requested) during the present process, as shown in Table 6. The alleged assailant is provided with a unique identifier (ID). Information in the present process about the alleged assailant, if known, includes the first and last name of the alleged assailant and other characteristics, including distinguishing features, such as birth marks, scars, height, hair and skin color, voice and any other visual or auditory distinctive features relative to the alleged assailant. Further, the city in which the alleged assailant was born, if known, and further, if known, names of family members, former and current, hang out locations, former and current addresses, former and current phones, as well as former and current jobs. Other information concerning the assailant may be requested as well.

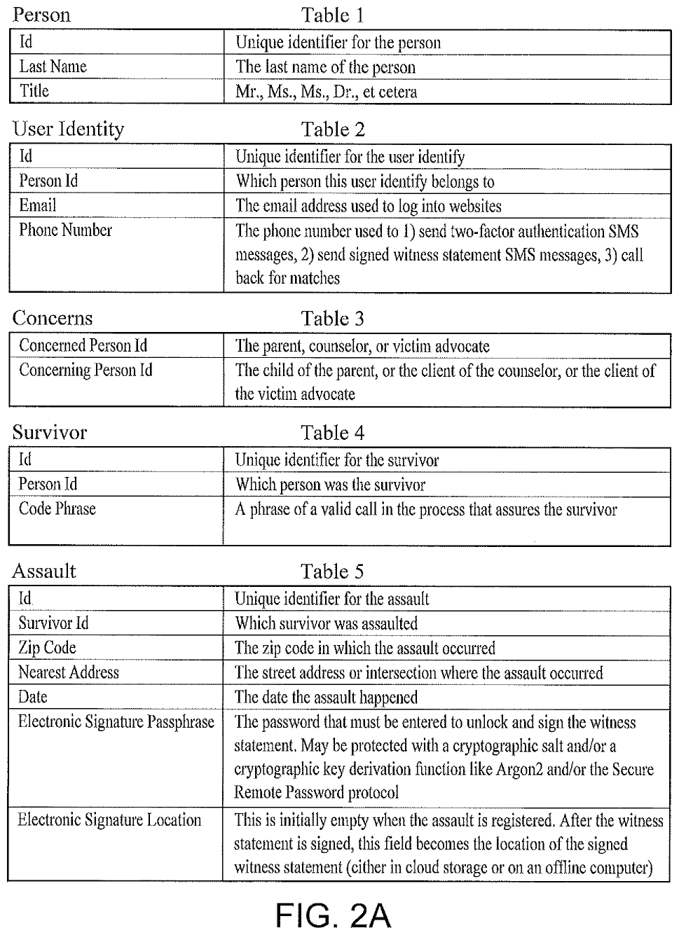

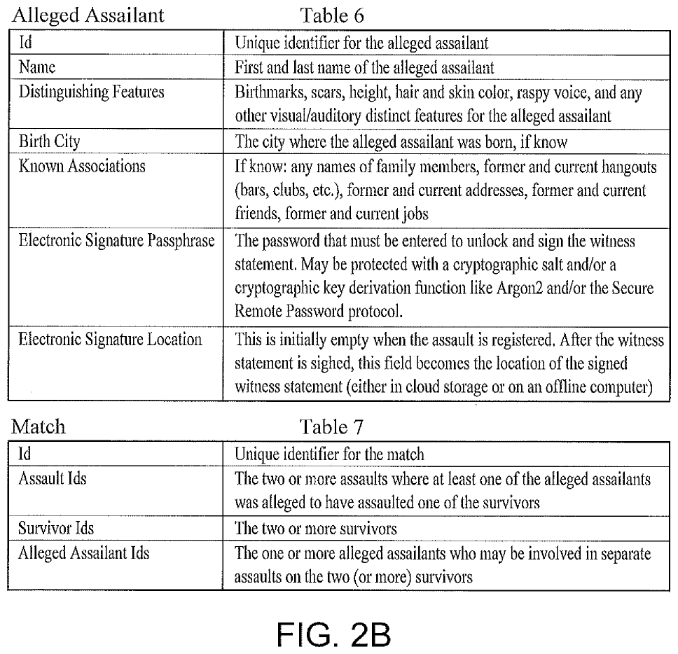

This information is set forth in Table 6 (FIG. 2B) labeled “alleged assailant”. This information is provided to an assault/assailant computer/database referred to at 16. This computer/database 16 is disconnected from the internet. The information is encrypted end-to-end. The survivor's web browser will have an assault/assailant database public key. The encrypted information is present in a transfer conduit 20, with a queue having an expiration date for the encrypted information. In the next step in the process, the assault/assailant information is retrieved from the queue, usually by a human, referred to as a process support individual (person) or entity, and saved to a USB drive or similar storage element. In another embodiment, the steps of the process accomplished by a human individual can be accomplished electronically. The USB drive will then be loaded by the process support individual into the assault/assailant computer/database 16, which includes private keys to decrypt the assault/assailant information in the USB drive. In the next step in the process, referred to as step 23, the assault/assailant computer database will prepare a prefilled, unsigned witness statement from the decrypted assault/assailant information. The witness statement is provided to a USB drive or printer or similar element. The witness statement is then transferred, usually by the process support individual to a computer for c-signing, which uploads the witness statement to a third party e-signature company, as shown at 24, which provides the prefilled witness statement to the survivor to review and sign. The c-signature company then provides a signed survivor statement (attestation) 27 which is made available to the assailant database. A first part of the process is now completed, involving the interaction between the survivor, a public website and an assault/assailant computer/database which is not connected to the internet. Encryption is provided to protect information provided by the survivor. A signed witness statement is produced which is placed into the assault/assailant database 16. It should be understood that other arrangements for verifying/attesting the information provided by the survivor can be utilized in order to produce a signed survivor's statement.

The next part of the present process involves several steps relative to matching the information from survivor 10 with other survivor information which has been stored in the assault/assailant computer database 16, either previously or subsequently.

In this part of the process it is important, as indicated above, that a survivor be correctly identified in the computer data base. In order to do this, as briefly explained above, a distinction is made between the term “survivor”, the term “person” and the term “user”. The term “survivor” (Table 4) is the name of the survivor and includes an indication of one (or more) assaults. The term “person” (Table 1) includes only the name and title of the person identified as the survivor. The term “user” (Table 2) includes the name of the person of Table 1 in combination with an email identification or a phone number. This distinction is necessary, as pointed out above, to distinguish between a survivor registering an assault with one email address or phone number and then accidentally using another email address or another phone number in a further communication or an additional assault.

This next part of the system involves producing a possible information match between that from survivor 10 and that from one or more additional survivors. Periodically, in the process, a witness match inquiry step 30 queries the assault/assailant database (which is not connected to the internet) to determine a possible match between the information from survivor 10 and information provided by other survivors. A comparison is made between the information from survivor 10 and the information from other survivors, relative to the information set forth in the tables or some specific subset of that information. If there is a match, the match information is added, shown at 37, to a match queue 36. Next in the process, the match information is obtained from the match queue, usually by the process support individual/person, shown at 38, by a printout or a USB drive element. An internet search of the alleged assailant's name and address is then made at 40, to reduce the possibility of misidentification. If the evidence indicates that the alleged assailant is not a match then the matching process terminates.

Further, if the alleged assailant has a common name, the process support individual may, but not necessarily, call the survivor 10 and the other survivors to ask for more discriminating information before moving the matching process forward.

If the matching process continues, the process support individual calls the individual survivors, using the prearranged code phrase provided by each survivor. This ensures that the call from the process support individual is valid. In the next step, the survivor 10 is told that there is a possible match. The survivor 10 is not provided the details about the other survivor(s) nor about the other assaults. If the survivor 10 wants to pursue the matter the survivor is given an authorization code by the process support individual to provide to a police officer/detective or an appropriate attorney, such as a personal injury attorney, as shown at 42. If the survivor 10 does not wish to pursue the matter, they are told that the other survivors have the option to proceed, as shown at 44. Only the police, a process support individual or an attorney will contact these other survivors. If one or more of the other survivors decide to proceed, they provide the police or an attorney the designated authorization code. This information is provided to a police website 52.

The police or attorney then go to the police website 52 and enter their authorization code. The police are then asked to send a fax 50 showing a police department publicly listed callback number. Attorneys are requested to send an email or fax showing attorney information, such as their bar number and phone number. In the next step, the process support individual determines that the police/attorney are ready to be authenticated.

The process support individual will pre-check the phone number and will call back the phone number, if okay, as shown at 54 for the survivor 10 or as shown at 43 for other survivors. During the phone call, the process support individual will ask for the authorization code again. If okay, the process support individual validates the phone call for the police/attorney as verfied. The police/attorney then will have access to the assault/alleged assailant details and witness statements as shown at 60 in the assault/assailant database 16 for further action.

In addition to the above, the process allows a “concerned” person, identified in Table 3 to locate the whereabouts of another person, such as a child, relative to a possible assault.

A further portion of the process involves the use of a witness/survivor ledger which assures police and the courts that a specific survivor in fact made a specific allegation prior to a particular date. The ledger is arranged as an electronic database table that can only add entries sequentially and further can never delete nor modify previous entries. Various cryptographic techniques can be used to ensure the above. As indicated above, a telephone call is used to authenticate the time of the assault registration. The ledger will include communication with a survivor requesting the code for the witness statement provided in response to the registration. Various time stamps can be used to guarantee the date of all the information provided by the survivor, at the specified times. The purpose of this portion of the system/process is to provide a guarantee that evidence presented in a court action concerning the assault allegations and the information associated therewith described above occurred at particular times, independently verified by a ledger and time stamping.

A further aspect of the invention involves a community social networking app for mobile phones. This app involves the use of the phone numbers in the cell phone address books of individuals having the app on their cell phone, referred to as app users herein. The user first installs the app, which is available on the internet. The app comprises the following process steps. Following installation of the mobile application (i.e, mobile app), the mobile app includes the first step of inquiring the user's mobile device for its globally unique identifier. Conventionally, the user's mobile device (iPhone, android, etc.) operating system includes a random number as the globally unique identifier, which acts in the app as a mailing address which the app can use to send and receive messages. These messages can be delivered to and received from any cell phone that has installed the mobile app of this invention.

In the next process step, the app will send a “hash” of the user's phone number and the device identifier to a server associated with present invention. The server will first record that the user is associated with the device identifier. In the next process step, the app inquires of the user which of the contacts in the user's cell phone address book the user desires to connect with, if in fact the contact is also a “survivor” as identified in Tables 2 or 4. In the next step, the user's app will determine which of the user's desired contacts has selected the user, identified by the desired contact's app. Periodically, such as once a day, the user's app will request a message to be sent to the user's desired contacts through the server. The message is encrypted with a “friend request” from the user and a hash of the contact's phone number. The server will drop any request that is not addressed to an existing survivor as identified in Tables 2 or 4. This results in all contacts in the user's address book being dropped except for the ones who are mutual survivors. The server will deliver the friend request to the mutual survivor's device. The mutual survivor's app will respond with an “accept friend request”. The mutual survivor's app then marks the contact as a “mutual survivor friend” and sends an acknowledgement message back to the user through the server. If a contact does not respond positively, the contact's app will delete the request with a “deny friend request”. This results in all contacts in the user's address book being dropped except for the mutual survivors who have responded positively to the user.

As a result, a community of survivors who are friends with each other and who indicated a desire to connect is created. This allows them to talk to each other as survivors and friends.

In one variation, the user's app may send the hashes of the phone number of the user's “would love to connect” to the server. Now, instead of the contacts apps auto-answering the message, the server can auto-answer whether the “friend request” is accepted and deliver the acceptance to both the user and the contacts who accepted.

Accordingly, a process has been described by which a survivor can conveniently register an assault on a public data base. Follow-up encrypted information about the assault/alleged assailant provided in a subsequent step is loaded into a computer/database which is not connected to the internet. The computer/database is then queried periodically to determine possible matches to the survivor's information. Any matches then are subsequently provided to the matching survivors who then have the option to move forward to authorize release of their information to the police or an attorney after specific steps of verification to guarantee confidentiality.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A survivor assault matching process, comprising the steps of:
providing an opportunity for an assault survivor to register at a website;
prompting the survivor to provide factual information about the assault;
encrypting the provided factual information;
providing the encrypted factual information to a computer with database not connected to the internet;
periodically inquiring of the computer with database whether or not the information supplied by one assault survivor matches information provided by other assault survivors; and
in the event there is a match, providing the one survivor the opportunity to receive an authorization code, which authorization code is then provided to police or an attorney for possible further action, including accessing the matched information from the one survivor and the other survivors.

2. The process of claim 1, including the step of encouraging the one survivor to take particular steps including visiting a hospital for care and/or seeking counseling.

3. The process of claim 1, including the step of directing the survivor to review the matched information.

4. The process of claim 1, including the step of verifying the accuracy of the matched information concerning an alleged assailant.

5. The process of claim 1, including the step of the police providing a call back number to validate the assault information being accessible,

6. The process of claim 1, wherein the assault information includes the address of the assault and the assault date, and wherein the information about the alleged assailant includes the name of the alleged assailant, the address of the assailant and distinguishing features of the alleged assailant.

7. The process of claim 1, including the step of providing the encrypted information to a transfer conduit, obtaining the information in the transfer conduit in a separate drive element and providing the separate drive information to the computer with data base.

8. The process of claim 1, wherein the information in the transfer conduit is obtained by an individual and provided by said individual to the computer with data base.

9. The process of claim 1, including the step of providing authorization codes to other survivors.

10. The process of claim 1, including the step of communicating between the survivor and the police or attorney to validate that the police or attorney can have access to the matched information for the computer with data base.

11. The process of claim 1, including the steps of compiling a ledger which includes time stamping the information provided by the one survivor.

12. The process of claim 1, wherein the process includes the step of allowing a concerned person to locate the whereabouts of another person concerning a possible assault.

13. An application program for installation and use on a user's mobile phone capable of running an app, wherein the user's mobile phone has a plurality of contacts with phone numbers in the user's mobile phone address book, the application program comprising the steps of:
request the user's mobile phone for its global identifier;
transmit a hash of the user's phone number and the user's global identifier to a server, wherein the server records that the user is associated with the mobile phone's global identifier;
request the user to select which of the contacts in the user's address book the user desires to connect with if the contact is an assault survivor;
identifying those contacts who are survivors of an assault who have selected the user in their apps;
periodically messaging the user's desired contacts who are survivors with a friend request, dropping all other contacts, and label those contacts who are survivors and who answer with an acceptance of the friend request from the user as a mutual survivor friend, enabling the user and the mutual survivor friend to communicate with each other.

14. The mobile app of claim 13, including the step of deleting all messages to any contact who is an assault survivor who also denies a friend request.
